(19) United States
(12) Patent Application Publication
(10) Pub. No.: US 2009/0315869 A1
(43) Pub. Date: Dec. 24, 2009

(54) DIGITAL PHOTO FRAME, INFORMATION PROCESSING SYSTEM, AND CONTROL METHOD

(75) Inventors: Ryohei SUGIHARA, Tokyo (JP); Seiji TATSUTA, Tokyo (JP); Yoichi IBA, Tokyo (JP); Miho KAMEYAMA, Tokyo (JP); Hayato FUJIGAKI, Kawaguchi-shi (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/486,312

(22) Filed: Jun. 17, 2009

(30) Foreign Application Priority Data
Jun. 18, 2008 (JP) 2008-159111

(51) Int. Cl. G09G 5/00

(52) U.S. Cl. 345/204; 345/156

(57) ABSTRACT

A digital photo frame includes a display section, a display control section, a detection information acquisition section that acquires detection information detected by a user detection sensor, and a user state determination section that determines at least one of a positional relationship between a user and the display section, an observation state of the user with respect to the display section, and whether or not the user is positioned within a detection range. The display control section changes a display state of an image displayed on the display section corresponding to at least one of the positional relationship between the user and the display section, the observation state of the user with respect to the display section, and whether or not the user is positioned within the detection range.

Japanese Patent Application No. 2008-159111 filed on Jun. 18, 2008, is hereby incorporated by reference in its entirety.

### BACKGROUND

The present invention relates to a digital photo frame, an information processing system, a control method, and the like.

In recent years, a digital photo frame has attracted attention as a device that can easily reproduce an image photographed by a digital camera such as a digital still camera. The digital photo frame is a device that is formed so that a photograph placement area of a photo stand is replaced by a liquid crystal display. The digital photo frame reproduces digital image data (electronic photograph) that is read via a memory card or a communication device.

For example, JP-A-2000-324473 discloses related-art digital photo frame technology. In JP-A-2000-324473, a telephone line connection unit is provided in a digital photo stand (digital photo frame) to form a transmission line between the photo stand and a cable or wireless telephone line.

However, a related-art digital photo frame has only a function of reproducing an image photographed by a digital camera or the like, but cannot perform display control that reflects the user state or the like. Therefore, an image reproduced by a related-art digital photo frame is monotonous (i.e., various images cannot be displayed for the user).

### SUMMARY

According to one aspect of the invention, there is provided a digital photo frame comprising:

a display section that displays an image;

a display control section that controls the display section;

a detection information acquisition section that acquires detection information detected by a user detection sensor; and

a user state determination section that determines at least one of a positional relationship between a user and the display section, an observation state of the user with respect to the display section, and whether or not the user is positioned within a detection range,

the display control section changing a display state of the image displayed on the display section corresponding to at least one of the positional relationship between the user and the display section, the observation state of the user with respect to the display section, and whether or not the user is positioned within the detection range.

According to another aspect of the invention, there is provided an information processing system comprising:

a display instruction section that instructs a display section of a digital photo frame to display an image;

a detection information acquisition section that acquires detection information detected by a user detection sensor; and

a user state determination section that determines at least one of a positional relationship between a user and the display section, an observation state of the user with respect to the display section, and whether or not the user is positioned within a detection range,

the display instruction section performing a display instruction to change a display state of the image displayed on the display section corresponding to at least one of the positional relationship between the user and the display section, the observation state of the user with respect to the display section, and whether or not the user is positioned within the detection range.

According to another aspect of the invention, there is provided a method of controlling a digital photo frame comprising:

acquiring detection information detected by a user detection sensor;

determining at least one of a positional relationship between a user and a display section of the digital photo frame, an observation state of the user with respect to the display section, and whether or not the user is positioned within a detection range; and

changing a display state of an image displayed on the display section corresponding to at least one of the positional relationship between the user and the display section, the observation state of the user with respect to the display section, and whether or not the user is positioned within the detection range.

### BRIEF DESCRIPTION OF THE DRAWINGS

FIGS. 1A and 1B show examples of a digital photo frame.

FIG. 2 shows a configuration example of a digital photo frame according to one embodiment of the invention.

FIGS. 3A and 3B are views illustrative of a method that changes the degree of detail of a display image corresponding to distance.

FIGS. 4A and 4B are views illustrative of a method that changes the number of screen splits of a display image corresponding to distance.

FIGS. 5A and 5B are views illustrative of a method that detects the distance between the user and a display section.

FIGS. 6A and 6B are views illustrative of a method that changes the display state of a display image corresponding to whether the user is gazing at a display section.

FIGS. 7A and 7B are views illustrative of a method that changes the display state of a display image corresponding to whether the user is gazing at a display section.

FIGS. 8A and 8B are views illustrative of a method that changes the display state of a display image corresponding to whether the user is gazing at a display section.

FIG. 9A to 9C are views illustrative of a user gaze state detection method.

FIG. 10 shows a specific example of a display state change method according to one embodiment of the invention.

FIG. 11 shows an example of a data structure that implements a display state change method according to one embodiment of the invention.

FIG. 12 is a flowchart illustrative of a specific processing example according to one embodiment of the invention.

FIG. 13 is a flowchart illustrative of a gaze state detection process.

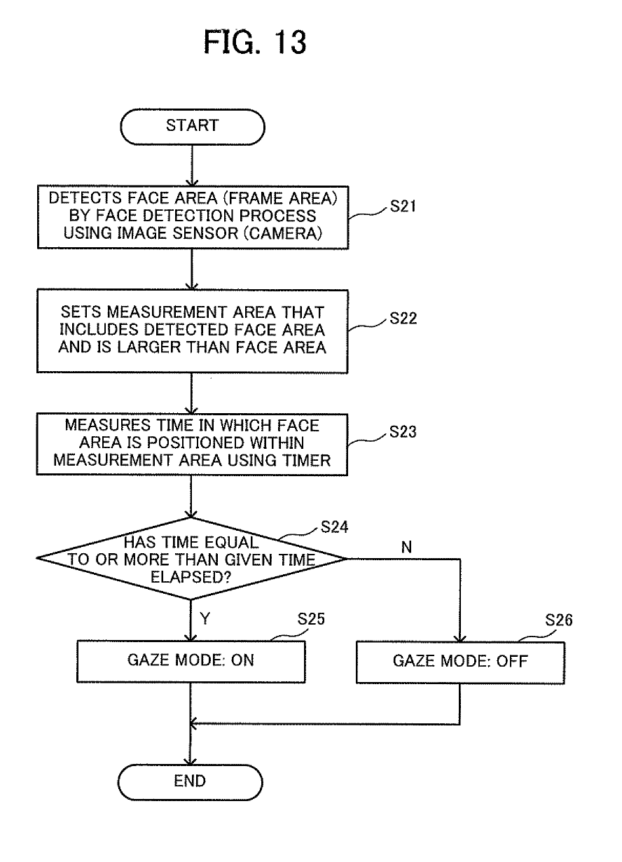

FIG. 14 shows a first modification of one embodiment of the invention.

FIG. 15 shows a home sensor installation example.

FIG. 16 shows a second modification of one embodiment of the invention.

### DESCRIPTION OF EXEMPLARY EMBODIMENTS

Several aspects of the invention may provide a digital photo frame, an information processing system, a control method, and the like that can implement display control that reflects the user state.

According to one embodiment of the invention, there is provided a digital photo frame comprising:

a display section that displays an image;

a display control section that controls the display section;

a detection information acquisition section that acquires detection information detected by a user detection sensor; and

a user state determination section that determines at least one of a positional relationship between a user and the display section, an observation state of the user with respect to the display section, and whether or not the user is positioned within a detection range,

the display control section changing a display state of the image displayed on the display section corresponding to at least one of the positional relationship between the user and the display section, the observation state of the user with respect to the display section, and whether or not the user is positioned within the detection range.

According to this embodiment, the detection information detected by the user detection sensor is acquired, and the user state is determined based on the detection information. The display state of the image displayed on the display section changes corresponding to the positional relationship between the user and the display section, the observation state of the user, or whether or not the user is positioned within the detection range. Therefore, an image that reflects the user state (e.g., the positional relationship between the user and the display section) is displayed on the display section of the digital photo frame so that a novel digital photo frame can be provided.

In the digital photo frame,

the user state determination section may determine a distance between the user and the display section as the positional relationship between the user and the display section; and

the display control section may change the display state of the image displayed on the display section corresponding to the distance between the user and the display section.

According to this configuration, the display state of the image displayed on the display section is changed corresponding to the distance between the user and the display section. Therefore, various of types of image representation that reflects the distance between the user and the display section can be implemented.

In the digital photo frame,

the display control section may increase the degree of detail of the image displayed on the display section as the distance between the user and the display section decreases.

According to this configuration, an image that contains a larger amount of information or an image with a high degree of detail can be presented to the user as the distance between the user and the display section decreases.

In the digital photo frame,

the display control section may increase the number of screen splits of the image displayed on the display section as the distance between the user and the display section decreases.

According to this configuration, an image that contains a large amount of information or an image with a high degree of detail can be presented to the user by increasing the number of screen splits of the image as the distance between the user and the display section decreases.

In the digital photo frame,

the display control section may decrease the size of a character displayed on the display section as the distance between the user and the display section decreases.

According to this configuration, an image that contains a larger number of characters can be presented to the user by decreasing the size of the characters as the distance between the user and the display section decreases.

The digital photo frame may further comprise:

a display mode change section that changes a display mode of the display section corresponding to the distance between the user and the display section.

According to this configuration, the display state of the image displayed on the display section can be changed corresponding to the distance between the user and the display section by a simple process that changes the display mode.

In the digital photo frame,

the display mode change section may change the display mode from a simple display mode to a detailed display mode when the distance between the user and the display section has decreased.

According to this configuration, the display mode can be changed from the simple display mode to the detailed display mode by simple control that changes the display mode from the simple display mode to the detailed display mode when the distance between the user and the display section has decreased.

In the digital photo frame,

the display mode change section may wait for a given time to avoid cancelling the detailed display mode after the display mode has changed from the simple display mode to the detailed display mode.

According to this configuration, a situation in which the detailed display mode is canceled immediately after the display mode has changed to the detailed display mode (i.e., the display mode frequently changes) can be effectively prevented.

In the digital photo frame,

the user detection sensor may be an image sensor that images the user; and

the user state determination section may detect a face area of the user based on imaging information from the image sensor, and may determine the distance between the user and the display section based on the size of the detected face area.

According to this configuration, the distance between the user and the display section can be determined by merely detecting the size of the face area while ensuring that the user is gazing at the display section.

In the digital photo frame,

the user detection sensor may be an image sensor that images the user; and

the user state determination section may determine the distance between the user and the display section by performing an auto-focus process on the user.

According to this configuration, the distance between the user and the display section or the presence of the user can be determined by utilizing a known auto-focus process.

In the digital photo frame,

the user detection sensor may be an ultrasonic sensor; and

the user state determination section may determine the distance between the user and the display section using the ultrasonic sensor.

In the digital photo frame,

the user state determination section may determine whether or not the user is gazing at the display section as the observation state of the user; and

the display control section may change the display state of the image displayed on the display section corresponding to whether or not the user is gazing at the display section.

According to this configuration, the display state of the image displayed on the display section is changed corresponding to whether or not the user is gazing at the display section. Therefore, various of types of image representation that reflects the gaze state of the user can be implemented.

In the digital photo frame,

the display control section may change the display state of the image displayed on the display section corresponding to gaze count information that indicates the number of times that the user has gazed at the display section.

According to this configuration, since the display state of the image displayed on the display section is changed while reflecting the gaze count information, more intelligent display control can be implemented.

In the digital photo frame,

the display control section may change the image displayed on the display section from a first image to a gaze image corresponding to the first image when the number of times that the user has gazed at the first image within a given time is equal to or more than a given number.

According to this configuration, the gaze image can be displayed on the display section when the number of times that the user has gazed at the first image within a given time is equal to or more than a given number.

In the digital photo frame,

the display control section may change a display frequency of a first image or an image relevant to the first image based on the gaze count information that indicates the number of times that the user has gazed at the first image within a given time.

According to this configuration, the display frequency of the first image or an image relevant to the first image can be increased when the number of times that the user has gazed at the first image increases, for example.

In the digital photo frame,

the display control section may change the image displayed on the display section from a first image to a gaze image corresponding to the first image when the user state determination section has determined that the user is gazing at the first image.

According to this configuration, the gaze image can be displayed on the display section when the user has gazed at the first image.

In the digital photo frame,

the display control section may sequentially display first to Nth (N is an integer equal to or larger than two) images on the display section when the user state determination section has determined that the user is not gazing at the display section, and may display a gaze image on the display section when the user state determination section has determined that the user is gazing at the display section when a Kth (1≦K≦N) image among the first to Nth images is displayed, the gaze image being an image relevant to the Kth image or a detailed image of the Kth image.

According to this configuration, when the user is gazing at the Kth image among the first to Nth images, the image relevant to the Kth image or the detailed image of the Kth image can be displayed as the gaze image. Specifically, an image relevant to or a detailed image of the image in which the user is interested can be displayed, for example.

In the digital photo frame,

the user state determination section may determine a distance between the user and the display section as the positional relationship between the user and the display section; and

the display control section may display a detailed image of the gaze image on the display section when the user state determination section has determined that the user has approached the display section when the gaze image is displayed.

According to this configuration, when the user has approached the display section when the gaze image is displayed, the detailed image of the gaze image can be displayed on the display section. Therefore, an image that contains a large amount of information or an image with a high degree of detail can be presented to the user.

In the digital photo frame,

the display control section may sequentially display first to Mth (M is an integer equal to or larger than two) gaze images on the display section as the gaze image when the user state determination section has determined that the user has not approached the display section, and may display a detailed image of an Lth (1≦L≦M) gaze image among the first to Mth gaze images on the display section when the user state determination section has determined that the user has approached the display section when the Lth gaze image is displayed on the display section.

According to this configuration, the first to Mth gaze images are displayed on the display section when the user has not approached the display section. When the user has approached the display section, the detailed image of the Lth gaze image is displayed.

In the digital photo frame,

the user detection sensor may be an image sensor that images the user; and

the user state determination section may detect a face area of the user based on imaging information from the image sensor, may set a measurement area that includes the detected face area and is larger than the face area, may measure a time in which the face area is positioned within the measurement area, and may determine whether or not the user is gazing at the display section based on the measured time.

According to this configuration, the gaze state of the user can be detected by effectively utilizing the face detection process.

The digital photo frame may further comprise:

a display mode change section that changes a display mode of the display section corresponding to whether or not the user is gazing at the display section.

According to this configuration, the display state of the image displayed on the display section can be changed corresponding to the gaze state of the user by a simple process that changes the display mode.

In the digital photo frame,

the display mode change section may wait for a given time to avoid cancelling a gaze mode after the display mode has changed to the gaze mode.

According to this configuration, a situation in which the gaze mode is canceled immediately after the display mode has changed to the gaze mode (i.e., the display mode frequently changes) can be effectively prevented.

In the digital photo frame,

the user state determination section may determine whether or not the user is positioned within the detection range; and

the display control section may cause the display section to be turned ON when the user state determination section has determined that the user is positioned within the detection range.

According to this configuration, since the display section is not turned ON when the user is not positioned within the detection range, a reduction in power consumption and the like can be implemented.

In the digital photo frame,

the user state determination section may determine whether or not the display section is positioned within a field-of-view range of the user as the observation state of the user after the display section has been turned ON; and

the display control section may sequentially display first to Nth images on the display section when the user state determination section has determined that the display section is positioned within the field-of-view range of the user.

According to this configuration, the first to Nth images can be sequentially displayed when the display section has been positioned within the field-of-view range of the user after the display section has been turned ON. Therefore, images or the like registered by the user can be sequentially displayed, for example.

According to another embodiment of the invention, there is provided an information processing system comprising:

a display instruction section that instructs a display section of a digital photo frame to display an image;

a detection information acquisition section that acquires detection information detected by a user detection sensor; and

a user state determination section that determines at least one of a positional relationship between a user and the display section, an observation state of the user with respect to the display section, and whether or not the user is positioned within a detection range,

the display instruction section performing a display instruction to change a display state of the image displayed on the display section corresponding to at least one of the positional relationship between the user and the display section, the observation state of the user with respect to the display section, and whether or not the user is positioned within the detection range.

According to another embodiment of the invention, there is provided a method of controlling a digital photo frame comprising:

acquiring detection information detected by a user detection sensor;

determining at least one of a positional relationship between a user and a display section of the digital photo frame, an observation state of the user with respect to the display section, and whether or not the user is positioned within a detection range; and

changing a display state of an image displayed on the display section corresponding to at least one of the positional relationship between the user and the display section, the observation state of the user with respect to the display section, and whether or not the user is positioned within the detection range.

Embodiments of the invention are described below. Note that the following embodiments do not in any way limit the scope of the invention laid out in the claims. Note that all elements of the following embodiments should not necessarily be taken as essential requirements for the invention.

1. Configuration

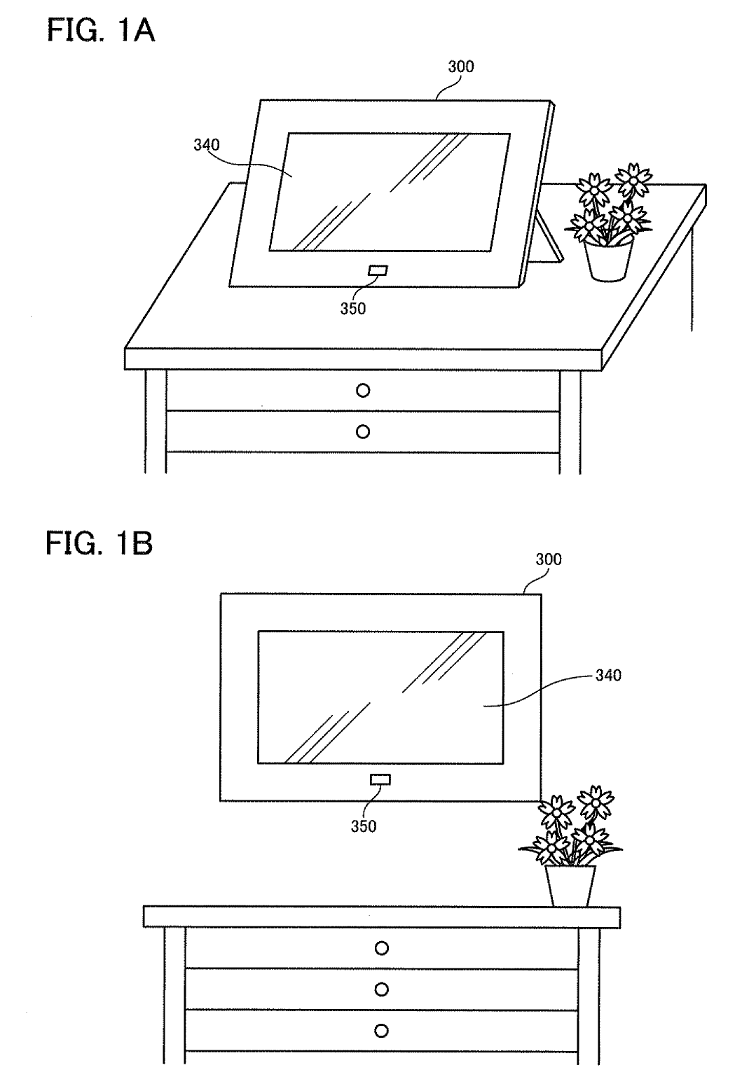

FIG. 1A shows an example of a digital photo frame 300 (digital photo player or image reproduction device) according to one embodiment of the invention. FIG. 1A shows an example of a photo stand-type digital photo frame. The digital photo frame 300 is set up by the user in an arbitrary place in a house or the like. The digital photo frame 300 reproduces content information (e.g., digital image data or digital sound data) (image reproduction or sound reproduction). The digital photo frame 300 can automatically reproduce content information (media information) (e.g., image) even if the user does not issue reproduction instructions. For example, the digital photo frame 300 automatically displays a photo slide show, or automatically reproduces an image.

The digital photo frame 300 may be a wall-hanging digital photo frame (see FIG. 1B) instead of a photo stand-type digital photo frame (see FIG. 1A), for example. As the wall-hanging digital photo frame, electronic paper implemented by an electrophoretic display or the like may be used. A content information reproduction button or the like may be provided in the digital photo frame 300, or the digital photo frame 300 may be configured so that the user can issue reproduction instructions using a remote controller.

The digital photo frame 300 may include a memory card interface (e.g., SD card). Alternatively, the digital photo frame 300 may include a wireless communication interface (e.g., wireless LAN or Bluetooth) or a cable communication interface (e.g., USB). For example, when the user has stored content information in a memory card and inserted the memory card into a memory card interface of the digital photo frame 300, the digital photo frame 300 automatically reproduces the content information stored in the memory card (e.g., displays a slide show). Alternatively, when the digital photo frame 300 has received content information from the outside via wireless communication or cable communication, the digital photo frame 300 reproduces the content information (automatic reproduction process). For example, when a portable electronic instrument (e.g., digital camera or portable telephone) possessed by the user has a wireless communication function (e.g., Bluetooth), the content information is transferred from the portable electronic instrument to the digital photo frame 300 by utilizing the wireless communication function. The digital photo frame 300 reproduces the content information transferred from the portable electronic instrument.

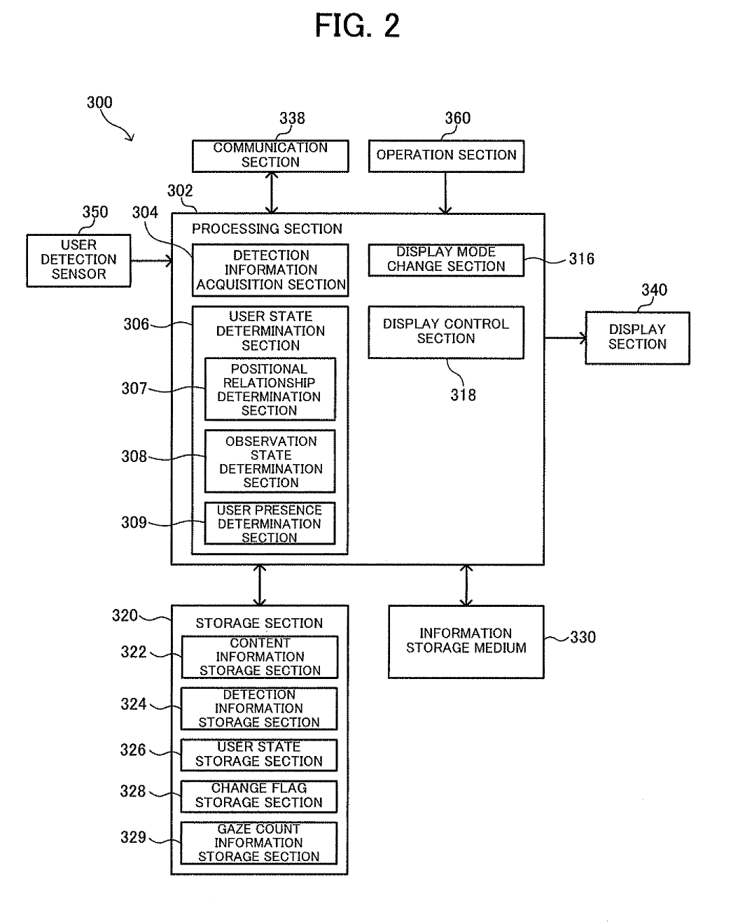

FIG. 2 shows a configuration example of the digital photo frame 300. The digital photo frame 300 includes a processing section 302, a storage section 320, a communication section 338, a display section 340, a user detection sensor 350, and an operation section 360. Note that various modifications may be made, such as omitting some (e.g., communication section, operation section, or user detection sensor) of the elements, or adding other elements (e.g., speaker).

The processing section 302 performs a control process and a calculation process. For example, the processing section 302 controls each section of the digital photo frame 300, or controls the entire digital photo frame 300. The function of the processing section 302 may be implemented by hardware such as a processor (e.g., CPU) or an ASIC (e.g., gate array), a program stored in an information storage medium 330, or the like.

The storage section 320 serves as a work area for the processing section 302, the communication section 338, and the like. The function of the storage section 320 may be implemented by a memory (e.g., RAM), a hard disk drive (HDD), or the like. The storage section 320 includes a content information storage section 322 that stores content information (e.g., image or sound), a detection information storage section 324 that stores acquired detection information, a user state storage section 326 that stores a specified user state, a change flag storage section 328 that stores a display mode change flag, and a gaze count information storage section 329 that stores gaze count information about the user.

The information storage medium 330 (computer-readable medium) stores a program, data, and the like. The function of the information storage medium 330 may be implemented by a memory card, an optical disk, or the like. The processing section 302 performs various processes according to this embodiment based on a program (data) stored in the information storage medium 330. Specifically, the information storage medium 330 stores a program that causes a computer (i.e., a device that includes an operation section, a processing section, a storage section, and an output section) to function as each section according to this embodiment (i.e., a program that causes a computer to execute the process of each section).

The communication section 338 (communication interface) exchanges information with an external device (e.g., server or portable electronic instrument) via wireless communication or cable communication. The function of the communication section 338 may be implemented by hardware (e.g., communication ASIC or communication processor) or communication firmware.

The display section 340 displays an image (i.e., content information). The display section 340 may be implemented by a liquid crystal display, a display that uses a light-emitting element (e.g., organic EL element), an electrophoretic display, or the like.

The user detection sensor 350 (human sensor) detects the user (e.g., user state), and outputs detection information based on the detection result. In this embodiment, the user detection sensor 350 is used to determine the positional relationship between the user (human) and the display section 340 (display screen or digital photo frame), the observation state of the user with respect to the display section 340, or whether or not the user is positioned within the detection range, for example.

As the user detection sensor 350, a human sensor such as a pyroelectric sensor may be used. The pyroelectric sensor receives infrared radiation emitted from a human or the like, converts the infrared radiation into heat, and converts the heat into charges due to the pyroelectricity of the element. Whether or not the user (human) is positioned within the detection range (detection area), the movement of the user positioned within the detection range, or the like can be detected by utilizing the pyroelectric sensor.

As the user detection sensor 350, an image sensor such as a CCD or a CMOS sensor may also be used. The image sensor is an optical sensor that converts one-dimensional or two-dimensional optical information into a time-series electrical signal. Whether or not the user is positioned within the detection range, the movement of the user positioned within the detection range, or the like can be detected by utilizing the image sensor. The positional relationship between the user and the display section 340 (e.g., the distance between the user and the display section 340 or the angle of the line of sight of the user with respect to the display section 340) can also be detected by a face detection process (face image recognition process) using the image sensor. The observation state of the user (e.g., whether or not the display section 340 is positioned within the field of view of the user, or whether or not the user is gazing at the display section 340) can also be detected using the image sensor. It is also possible to detect whether or not the user approaches the display section 340.

As the user detection sensor 350, a distance sensor such as an ultrasonic sensor may also be used. The ultrasonic distance sensor emits an ultrasonic pulse and receives the ultrasonic pulse reflected by a human or the like to determine the distance from the time required to receive the ultrasonic pulse.

Note that the sensor such as the user detection sensor 350 may be a sensor device, or may be a sensor instrument that includes a control section, a communication section, and the like in addition to the sensor device. The detection information may be primary information directly obtained from the sensor, or may be secondary information obtained by processing (information processing) the primary information.

The user detection sensor 350 may be directly installed in the digital photo frame 300, or a home sensor or the like may be used as the user detection sensor 350. When installing the user detection sensor 350 in the digital photo frame 300, the user detection sensor 350 may be installed in the frame of the digital photo frame 300, as shown in FIG. 1A, for example. Alternatively, the user detection sensor 350 and the digital photo frame 300 may be connected using a cable or the like.

The operation section 360 allows the user to input information. The operation section 360 may be implemented by an operation button, a remote controller, or the like. The user can register himself, or register desired reproduction target contents (favorite images) using the operation section 360.

The processing section 302 includes a detection information acquisition section 304, a user state determination section 306, a display mode change section 316, and a display control section 318. Note that various modifications may be made, such as omitting some (e.g., user state determination section or display mode change section) of the elements or adding other elements.

The detection information acquisition section 304 acquires the detection information detected by the user detection sensor 350. For example, when the user detection sensor 350 has detected the user state or the like and output the detection information (imaging (sensing) information), the detection information acquisition section 304 acquires the detection information. The detection information acquired by the detection information acquisition section 304 is stored in the detection information storage section 324 of the storage section 320. When using an external sensor such as a home sensor as the user detection sensor 350, the communication section 338 receives the detection information output from the user detection sensor 350, and the detection information acquisition section 304 acquires the detection information received by the communication section 338.

The user state determination section 306 determines the user state or the like based on the detection information acquired by the detection information acquisition section 304. For example, the user state determination section 306 determines at least one of the positional relationship between the user (human) and the display section 340, the observation state of the user with respect to the display section 340, and whether or not the user is positioned within the detection range. User state information that indicates the positional relationship between the user and the display section 340, the observation state of the user with respect to the display section 340, or whether or not the user is positioned within the detection range is stored in the user state storage section 326.

The positional relationship between the user and the display section 340 refers to the distance between the user and the display section 340, the line-of-sight direction of the user with respect to the display section 340, or the like. A positional relationship determination section 307 determines the positional relationship between the user and the display section 340. For example, the positional relationship determination section 307 determines the distance (distance information or distance parameter) between the user and the display section 340 as the positional relationship between the user and the display section 340.

The observation state refers to the field-of-view range or the gaze state of the user. Specifically, the observation state refers to whether or not the display section 340 is positioned within the field-of-view range (view volume) of the user, or whether or not the user is gazing at the display section 340. An observation state determination section 308 determines the observation state of the user. For example, the observation state determination section 308 determines whether or not the user is gazing at the display section 340 as the observation state of the user. A user presence determination section 309 determines whether or not the user is positioned within the detection range.

When an image sensor that images the user is provided as the user detection sensor 350, the user state determination section 306 (positional relationship determination section) detects the face area (rectangular frame area) of the user based on imaging information from the image sensor. The user state determination section 306 determines (estimates) the distance between the user and the display section 340 based on the size of the detected face area. The user state determination section 306 sets a measurement area that includes the detected face area and is larger than the face area. Specifically, the user state determination section 306 sets a measurement area that overlaps the face area. The user state determination section 306 measures the time in which the face area is positioned within the measurement area, and determines whether or not the user is gazing at the display section 340 based on the measured time. For example, the user state determination section 306 determines that the user is gazing at the display section 340 when the face area has been positioned within the measurement area for a period of time equal to or longer than a given time.

The user state determination section 306 may determine the distance between the user and the display section 340 by performing an auto-focus process (auto-focus function) on the user (described later). For example, when using an active method, a device that emits infrared radiation or an ultrasonic wave is provided in the digital photo frame 300 or the like, and a light-receiving sensor that receives infrared radiation or an ultrasonic wave is provided as the user detection sensor 350. The user state determination section 306 determines the distance between the user and the display section 340 or the like by detecting the light reflected by the user using the light-receiving sensor. When using a passive method, an image sensor is provided as the user detection sensor 350, and the distance between the user and the display section 340 or the like is detected by processing the image obtained by the user detection sensor 350 using a phase difference detection method or a contrast detection method.

The display mode change section 316 changes the display mode. For example, the display mode change section 316 changes the display mode corresponding to the user state (e.g., the positional relationship between the user and the display section 340 or the observation state of the user). Specifically, the display mode change section 316 changes the display mode of the display section 340 corresponding to the distance between the user and the display section 340. For example, the display mode change section 316 changes the display mode from a simple display mode to a detailed display mode when the distance between the user and the display section 340 has decreased (when the user has been determined to approach the display section 340). The display mode change section 316 also changes the display mode of the display section 340 corresponding to whether or not the user is gazing at the display section 340.

The display mode change section 316 waits for a given time before canceling the display mode after the display mode has changed. For example, when the display mode has been changed from the simple display mode to the detailed display mode, the display mode change section 316 waits for the detailed display mode to be canceled and changed to another display mode for a given time. Alternatively, when the display mode has been changed from a normal display mode or the like to a gaze mode, the display mode change section 316 waits for the gaze mode to be canceled and changed to another display mode for a given time.

The display mode is changed using a change flag stored in the change flag storage section 328. Specifically, when the user state determination section 306 has determined that the user state, a display mode change flag is set corresponding to the user state, and stored in the change flag storage section 328.

A tag is assigned to an image stored in the content information storage section 322. Specifically, a display mode tag (e.g., detailed display mode tag, simple display mode tag, gaze mode tag, and visitor mode tag), a content genre tag, or the like is assigned to each image. An image corresponding to the display mode can be read from the content information storage section 322 and displayed on the display section 340 when the display mode changes by utilizing the tag assigned to each image.

The display control section 318 controls the display section 340. For example, the display control section 318 causes the display section 340 to display an image based on the content information stored in the content information storage section 322. Specifically, the display control section 318 reads the display mode change flag set corresponding to the user state from the change flag storage section 328. The display control section 318 then reads the content information (e.g., image or sound) corresponding to the change flag read from the change flag storage section 328, from the content information storage section 322. The display control section 318 then performs a control process (e.g., writes data into a drawing buffer) that causes the display section 340 to display the image indicated by the content information read from the content information storage section 322.

In this embodiment, the display control section 318 changes the display state of the image displayed on the display section 340 based on at least one of the positional relationship between the user and the display section 340, the observation state of the user, and whether or not the user is positioned within the detection range.

For example, when the user state determination section 306 has determined the distance between the user and the display section 340 as the positional relationship between the user and the display section 340, the display control section 318 changes the display state of the image displayed on the display section 340 based on the distance between the user and the display section 340. For example, the display control section 318 increases the degree of detail of the image displayed on the display section 340, or increases the number of screen splits of the image displayed on the display section 340, or decreases the size (font size) of characters displayed on the display section 340 as the distance between the user and the display section 340 decreases.

Note that the display control section 318 need not necessarily change the display state of the image displayed on the display section 340 based on the distance between the user and the display section 340. The display control section 318 may change the display state of the image displayed on the display section 340 based on a parameter (e.g., the size of the face area) equivalent to the distance between the user and the display section 340. The expression “changes the display state of the image” refers to changing a first image in a first display state to a second image in a second display state. For example, the image displayed on the display section 340 is changed from the first image to the second image that is a detailed image of the first image, or changed from the first image to the second image that is a simple image of the first image, or changed from the first image to the second image that is split into a plurality of areas.

When the user state determination section 306 has determined whether or not the user is gazing at the display section 340 as the observation state of the user, the display control section 318 changes the display state of the image displayed on the display section 340 based on whether or not the user is gazing at the display section 340. Specifically, when the user state determination section 306 has determined that the user is gazing at a first image, the display control section 318 changes the image displayed on the display section 340 from the first image to a gaze image corresponding to the first image. For example, when the user state determination section 306 has determined that the user is not gazing at the display section 340, the display control section 318 does not change the image displayed on the display section 340 from the first image to a gaze image that is an image relevant to the first image or a detailed image of the first image. On the other hand, when the user state determination section 306 has determined that the user is gazing at the display section 340, the display control section 318 changes the image displayed on the display section 340 from the first image to the gaze image. When the user state determination section 306 has determined that the user is not gazing at the display section 340, the display control section 318 sequentially displays first to Nth (N is an integer equal to or larger than two) images on the display section 340. The first to Nth images used herein refer to images that differ in genre or category. When the user state determination section 306 has determined that the user is gazing at the display section 340 (Kth image) when a Kth (1≦K≦N) image among the first to Nth images is displayed, the display control section 318 displays a gaze image (i.e., an image relevant to the Kth image or a detailed image of the Kth image) on the display section 340. When the user state determination section 306 has determined that the user has approached the display section 340 when the gaze image is displayed, the display control section 318 displays a detailed image of the gaze image. For example, when the user state determination section 306 has determined that the user does not approach the display section 340, the display control section 318 sequentially displays first to Mth (M is an integer equal to or larger than two) gaze images on the display section 340. When the user state determination section 306 has determined that the user has approached the display section 340 when an Lth (1≦L≦M) gaze image among the first to Mth gaze images is displayed, the display control section 318 displays a detailed image of the Lth gaze image.

Note that the relevant image is an image associated with the first image or the Kth image in advance as an image that is relevant to the content (information) of the first image or the Kth image. The detailed image is an image associated with the first image or the Kth image in advance as an image that shows the details of the content (information) of the first image or the Kth image. The relevant image and the detailed image are associated in advance with the first image or the Kth image in the content information storage section 322, for example.

The display control section 318 may change the display state of the image displayed on the display section 340 based on gaze count information (the gaze count or a parameter that changes corresponding to the gaze count) that indicates the number of times that the user has gazed at the display section 340. For example, the user state determination section 306 counts the gaze count of the user, and stores the gaze count in the gaze count information storage section 329 as the gaze count information. When the number of times that the user has gazed at the first image within a given time is equal to or more than a given number, the display control section 318 changes the image displayed on the display section 340 to the gaze image corresponding to the first image. For example, when the gaze count of the user is less than a given number, the display control section 318 does not change the image displayed on the display section 340 from the first image to the gaze image (i.e., an image relevant to the first image or a detailed image of the first image). On the other hand, when the gaze count of the user is equal to or more than a given number, the display control section 318 changes the image displayed on the display section 340 from the first image to the gaze image. The display control section 318 may change the display frequency of the first image or an image relevant to the first image based on the gaze count information that indicates the number of times that the user has gazed at the first image within a given time. For example, the display control section 318 increases the display frequency when the gaze count is equal to or more than a given number.

Suppose that the user state determination section 306 has determined whether or not the user is positioned within the detection range of the user detection sensor 350. For example, the user state determination section 306 has determined the presence or absence of the user using a pyroelectric sensor that enables a wide-range detection. When the user state determination section 306 has determined that the user is positioned within the detection range, the display control section 318 causes the display section 340 to be turned ON. For example, the display control section 318 causes a backlight of a liquid crystal display to be turned ON so that the user can observe the image displayed on the display section 340. When the user state determination section 306 has determined that the user is not positioned within the detection range, the display control section 318 causes the display section 340 to be turned OFF. For example, the display control section 318 changes the mode of the display section 340 from a normal mode to a power-saving mode to reduce power consumption.

For example, the user state determination section 306 determines whether or not the display section 340 is positioned within the field-of-view range of the user as the observation state of the user after the display section 340 has been turned ON. When the user state determination section 306 has determined that the user is positioned within the field-of-view range of the user, the display control section 318 causes the display section 340 to sequentially display the first to Nth images. The first to Nth images refer to images that differ in theme of the display contents, for example.

2. Change in Display State Corresponding to Positional Relationship

In this embodiment, the display state of the image displayed on the display section 340 is changed corresponding to the positional relationship between the user and the display section 340.

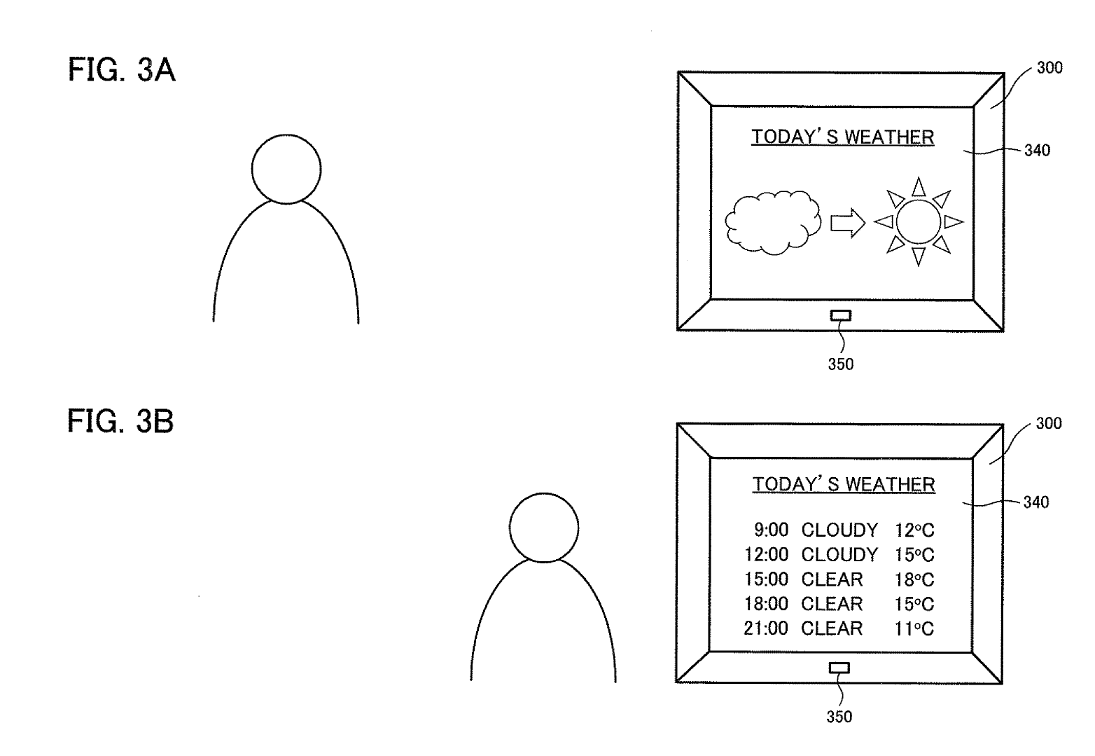

In FIGS. 3A and 3B, the degree of detail of the image displayed on the display section 340 is changed corresponding to the distance (positional relationship in a broad sense) between the user and the display section 340 (digital photo frame), for example. In FIG. 3A, the distance between the user and the display section 340 is equal to or greater than a given distance. In this case, a simple image (normal image) is displayed as a weather forecast image, for example. Specifically, the weather forecast image is displayed using large characters (font) and large icons. Note that the distance between the user and the display section 340 is detected by the user detection sensor 350.

In FIG. 3B, the distance between the user and the display section 340 is shorter than a given distance. Specifically, the user is interested in the information displayed on the display section 340, and has approached the display section 340. In this case, a detailed image is displayed as the weather forecast image. In FIG. 3B, an image that shows a detailed weather forecast is displayed using small characters and the like as compared with FIG. 3A.

In FIG. 3A, the simple image that shows a weather forecast using the icons is displayed so that the user who is positioned away from the display section 340 can easily observe the weather forecast. Specifically, the display mode change flag stored in the change flag storage section 328 shown in FIG. 2 is set to the simple display mode so that the simple image is displayed. In FIG. 3B, the detailed image that shows the detailed weather forecast every three hours is displayed on the assumption that the user is interested in today's weather and has approached the display section 340. Specifically, the display mode change flag stored in the change flag storage section 328 is changed to the detailed display mode so that the detailed image is displayed.

An image appropriate for the distance between the user and the display section 340 can be displayed by changing the degree of detail of the image displayed on the display section 340 corresponding to the distance between the user and the display section 340. In FIGS. 3A and 3B, the degree of detail of the image displayed on the display section 340 is changed in two stages corresponding to the distance between the user and the display section 340. Note that the degree of detail of the image displayed on the display section 340 may be changed in three or more stages.

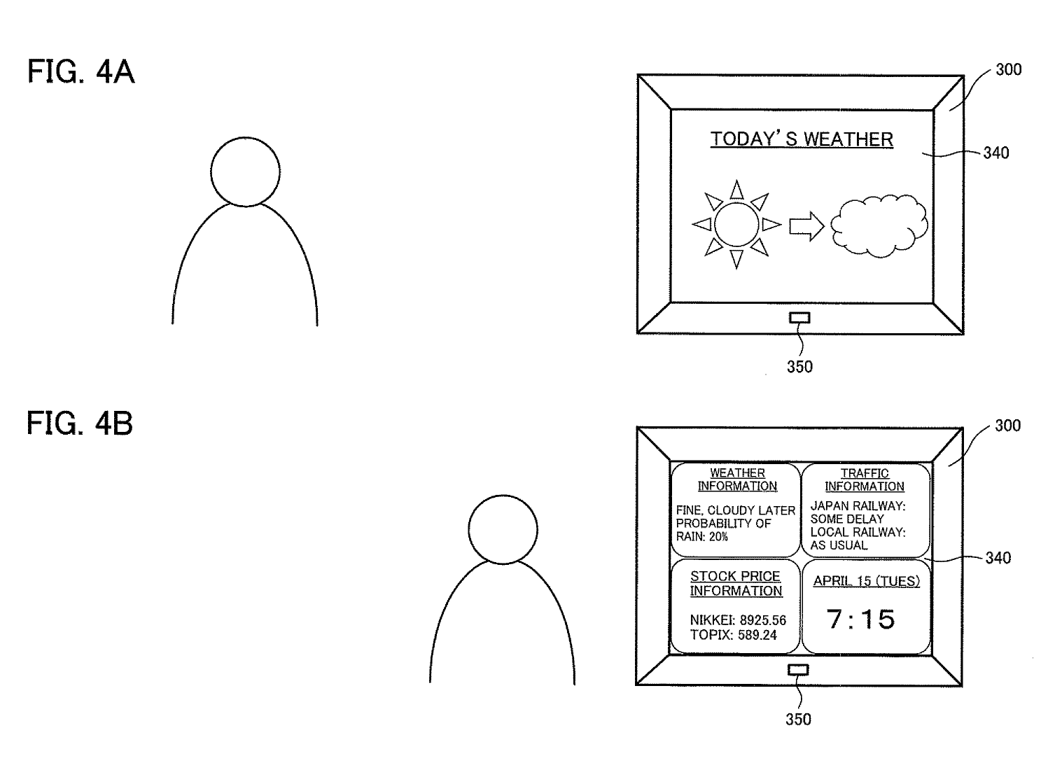

In FIGS. 4A and 4B, the number of screen splits of the image displayed on the display section 340 is changed corresponding to the distance (i.e., positional relationship) between the user and the display section 340. In FIG. 4A, the distance between the user and the display section 340 is equal to or greater than a given distance. In this case, an image of which the number of screen splits is one (i.e., an image that is not split) is displayed, for example.

In FIG. 4B, the distance between the user and the display section 340 is shorter than a given distance. In this case, an image of which the number of screen splits is four is displayed, for example. Specifically, the number of screen splits of the image displayed in FIG. 4B is larger than that of the image displayed in FIG. 4A. In FIG. 4A, an image that shows weather information is displayed. In FIG. 4B, an image that shows weather information, an image that shows stock price information, an image that shows traffic information, and an image that shows calendar information are displayed in first, second, third, and fourth split screens, respectively. In FIG. 4B, an image that shows detailed weather information and the like is displayed using small characters as compared with FIG. 4A.

In FIG. 4A, the weather forecast image is displayed using the entire display section 340 so that the user positioned away from the display section 340 can easily observe the image, for example. Specifically, the display mode change flag stored in the change flag storage section 328 is set to a single screen mode so that an image of which the number of screen splits is one is displayed. In FIG. 4B, the screen of the display section 340 is split since the user has approached the display section 340, and an image that shows stock price information, an image that shows traffic information, and an image that shows calendar information are displayed in addition to an image that shows weather information. Specifically, the display mode change flag stored in the change flag storage section 328 is changed to a four screen mode so that an image of which the number of screen splits is four is displayed.

An image appropriate for the distance between the user and the display section 340 can be displayed by changing the number of screen splits of the image displayed on the display section 340 corresponding to the distance between the user and the display section 340. In FIGS. 4A and 4B, the number of screen splits is changed in two stages. Note that the number of screen splits may be changed in three or more stages. Note also that the number of screen splits is arbitrary.

When changing the display state corresponding to the distance between the user and the display section 340, the distance between the user and the display section 340 may be the linear distance between the user and the display section 340, or may be the distance between the user and the display section 340 in the depth direction (Z direction). In this case, the distance between the user and the display section 340 includes a parameter (e.g., the face area described later) that is mathematically equivalent to the distance. For example, a parameter that changes corresponding to a change in distance may be employed.

The positional relationship between the user and the display section 340 is not limited to the distance between the user and the display section 340, but may be the angle formed by the line-of-sight direction of the user and the display screen of the display section 340, for example.

FIGS. 3A to 4B show examples in which the degree of detail, the number of screen splits, or the character size is changed as the display state. Note that a change in the display state according to this embodiment is not limited thereto. For example, the display state may be changed by displaying a relevant image or causing the display section 340 to be turned ON/OFF corresponding to the positional relationship between the user and the display section 340.

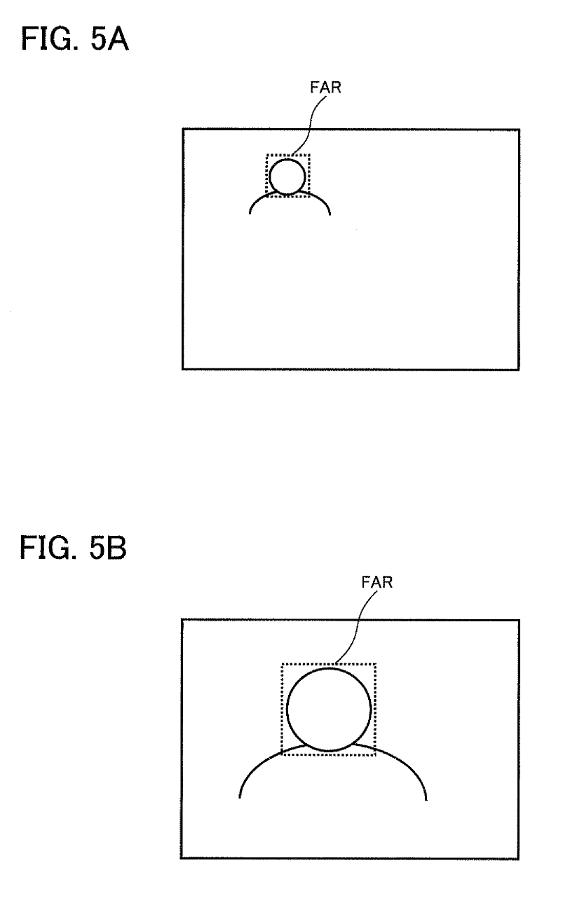

An example of a method of detecting the distance (positional relationship) between the user and the display section 340 is described below with reference to FIGS. 5A and 5B. In FIGS. 5A and 5B, an image sensor (camera) such as a CCD or a CMOS sensor is used as the user detection sensor 350. A face area FAR that is a rectangular frame area is detected based on imaging information from the image sensor, and the size of the detected face area FAR is calculated. The distance between the user and the display section 340 is determined based on the calculated size of the face area.

In FIG. 5A, since the size of the face area FAR is small (i.e., equal to or smaller than a given size), the user is determined to be positioned away from the display section 340 (i.e., the distance between the user and the display section 340 is long), for example. In this case, the image shown in FIG. 3A or 4A is displayed on the display section 340. In FIG. 5B, since the size of the face area FAR is large (i.e., larger than the given size), the user is determined to be positioned close to the display section 340 (i.e., the distance between the user and the display section 340 is short), for example. In this case, the image shown in FIG. 3B or 4B is displayed on the display section 340.

The face area may be detected in various ways. For example, it is necessary to determine the face area in the image obtained by the image sensor while distinguishing the face area from other objects in order to implement the face detection process. A face includes eyes, a nose, a mouth, and the like. The shape of each part and the positional relationship between the parts differ depending on individuals, but each part has an almost common feature. Therefore, the face is distinguished from other objects by utilizing such a common feature, and the face area is determined from the image. The color of the skin, the shape, the size, and the movement of the face, and the like may be used to determine the face area. When using the color of the skin, RGB data is converted into HSV data that consists of hue, luminance, and intensity, and the hue of the human skin is extracted.

Alternatively, an average face pattern generated from a number of human face patterns may be created as a face template. The face template is scanned on the screen of the image obtained by the image sensor to determine a correlation with the image obtained by the image sensor, and an area having the maximum correlation value is detected as the face area.

In order to increase the detection accuracy, a plurality of face templates may be provided as dictionary data, and the face area may be detected using the plurality of face templates. The face area may be detected taking account of information such as the features of the eyes, nose, and mouth, the positional relationship among the eyes, nose, and mouth, and the contrast of the face. Alternatively, the face area may be detected by statistical pattern recognition using a neural network model.

The detection method shown in FIGS. 5A and 5B has an advantage in that the distance between the user and the display section 340 can be detected based on the size of the face area FAR while detecting whether or not the user watches the display section 340. Specifically, since the correlation value with the face template decreases when the user is not gazing at the display section 340, the face area FAR is not detected. Therefore, the fact that the face area FAR has been detected means that the user is gazing at the display section 340 and the display section 340 is positioned within the field-of-view range of the user. An image appropriate for the distance between the user and the display section 340 can be displayed for the user who watches the image displayed on the display section 340 by detecting the size of the face area FAR in this state and changing the display state of the image as shown in FIGS. 3A to 4B. Therefore, a novel digital photo frame 300 can be provided.

Note that the user detection method is not limited to the method shown in FIGS. 5A and 5B. For example, the user may be detected by effectively utilizing an auto-focus function implemented by an ordinary camera, a camera of a portable telephone, or the like. Whether or not the user (human) is positioned in front of the digital photo frame 300 and the positional relationship (e.g., distance) between the user and the display section 340 can be determined by utilizing the auto-focus function.

For example, the focus is almost fixed when no one is present in a room. However, the auto-focus function works when the user has walked in front of the display section 340 of the digital photo frame 300, so that whether or not the user is present can be determined. When the user watches the display section 340 of the digital photo frame 300, the auto-focus function works in response to the presence of the user so that the camera automatically focuses on the user. Therefore, an approximate distance between the user and the display section 340 can be detected.

The auto-focus method is classified into an active method and a passive method. The active method emits infrared radiation, an ultrasonic wave, or the like to measure the distance from an object such as the user. Specifically, the distance from the object is measured by measuring the time elapsed before the reflected wave returns to the camera, for example. The active method has an advantage in that it is easy to focus on the object even in a dark place.

The passive method receives luminance information about the object using an image sensor (e.g., CCD sensor), and detects the distance (focal position) from the object by an electrical process. Specifically, the passive method measures the distance from the object using the image obtained by the image sensor. The passive method is classified into a phase difference detection method that detects a horizontal deviation of a luminance signal, a contrast detection method that detects the contrast of a luminance signal, and the like.

3. Change in Display State Corresponding to Observation State

In this embodiment, the display state of the image displayed on the display section 340 is changed corresponding to the observation state of the user. Specifically, the display state is changed corresponding to whether or not the user is gazing at the display section 340, whether or not the display section 340 is positioned within the field-of-view range of the user, or the like.

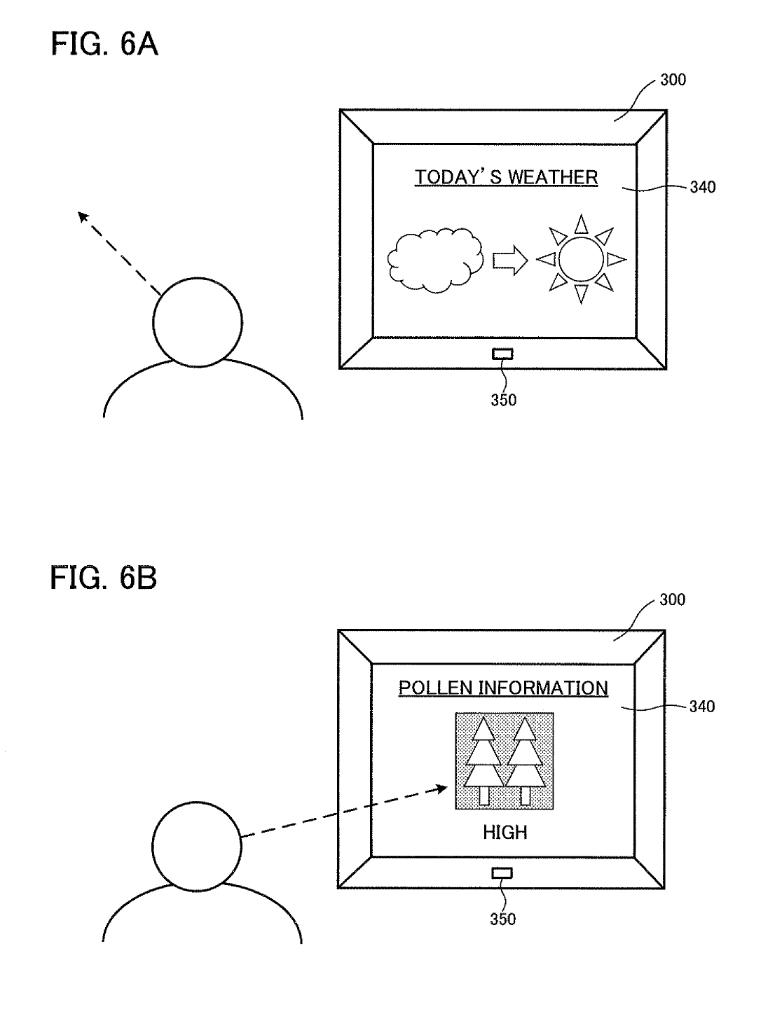

In FIGS. 6A and 6B, the display state of the image displayed on the display section 340 is changed corresponding to whether or not the user is gazing at the display section 340, for example. In FIG. 6A, the line-of-sight direction of the user does not aim at the display section 340 (i.e., the user is not gazing at the display section 340). In this case, a normal image (first image) is displayed as a weather forecast image, for example. Note that whether or not the user is gazing at the display section 340 may be detected using the user detection sensor 350.

In FIG. 6B, the user is gazing at the display section 340. For example, the display section 340 is positioned within the field-of-view range of the user for a period of time equal to or longer than a given time. In this case, an image relevant to the image shown in FIG. 6A (i.e., a gaze image that is an image relevant to the first image) is displayed. Specifically, while the weather forecast image is displayed in FIG. 6A, an image that shows pollen information is displayed in FIG. 6B as a weather forecast-relevant image.

For example, when the user is gazing at the display section 340 for a given time (see FIG. 6B), the image displayed on the display section 340 becomes monotonous if the image shown in FIG. 6A is continuously displayed.

In FIG. 6B, the image that shows pollen information (i.e., the image relevant to the image shown in FIG. 6A) is displayed on condition that the user is gazing at the display section 340 for a given time. Therefore, the display state of the image changes on condition that the user is gazing at the display section 340 so that a varied image can be displayed for the user. Moreover, various types of information can be efficiently presented to the user.

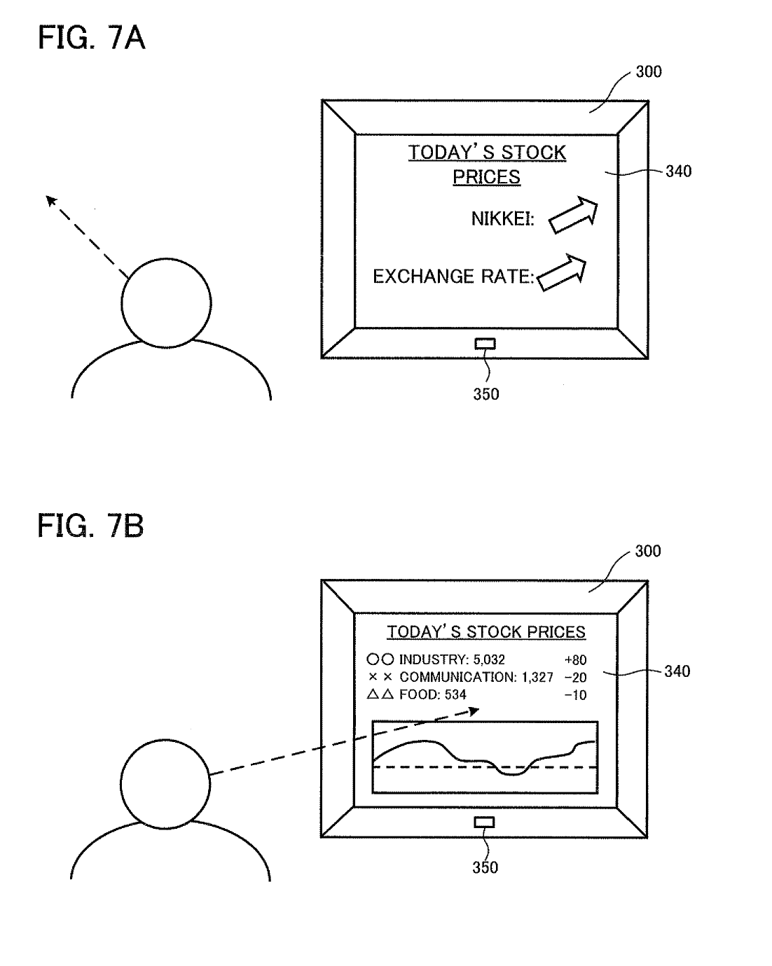

In FIGS. 7A and 7B, the image displayed on the display section 340 is changed from a simple image to a detailed image on condition that the user is gazing at the display section 340. In FIG. 7A, since the user is not gazing at the display section 340, a simple image (first image) is displayed as an image that shows stock information. Specifically, the average stock price and foreign exchange movements are simply displayed.

In FIG. 7B, since it has been determined that the user is gazing at the display section 340 for a given time, the image displayed on the display section 340 is changed to a detailed image (i.e., a gaze image that is a detailed image of the first image). Specifically, a detailed image that shows a change in individual stock prices is displayed. Therefore, the user can be informed of the details of stock price movements as a result of gazing at the display section 340. Note that the digital photo frame 300 may be configured so that the user can register (select) names to be displayed on the display section 340 in advance from a plurality of names (i.e., register (select) items to be displayed on the display section 340 from a plurality of items) using the operation section 360 or the like. In this case, an image that shows the details of stock prices of the names registered by the user as favorites is displayed when the user is gazing at the display section 340 in a state in which the simple image that shows stock information is displayed. Therefore, convenience to the user can be improved.

Note that a change in the display state based on the gaze state (observation state in a broad sense) of the user is not limited to FIGS. 6A to 7B. Various modifications may be made, such as changing the character size or the number of screen splits.

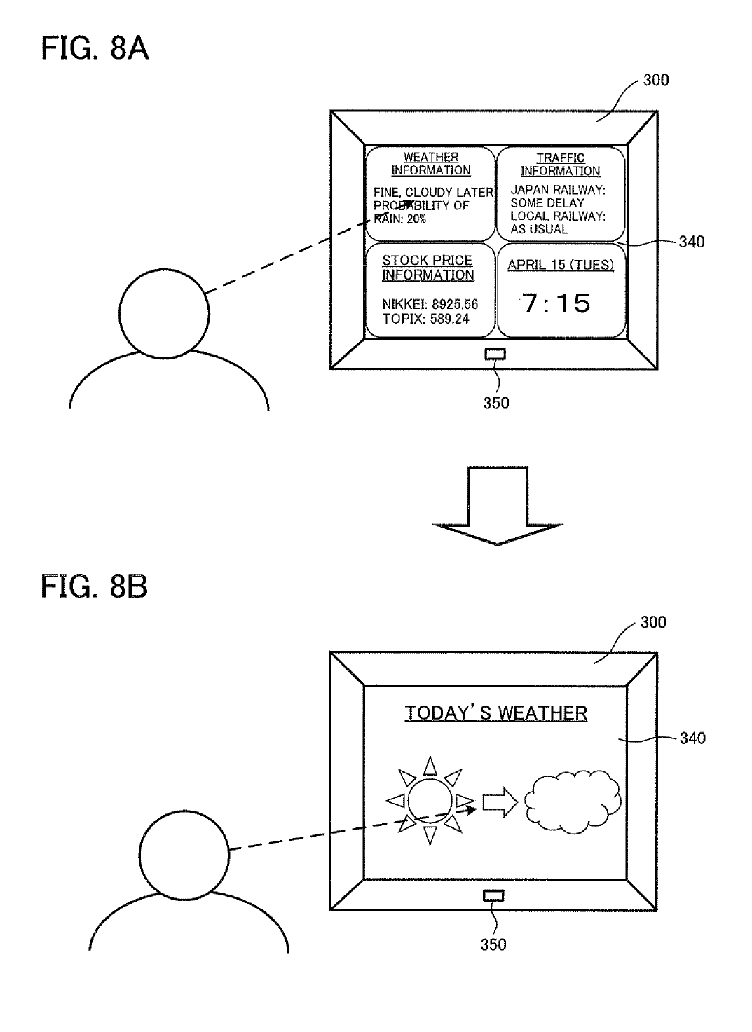

In FIG. 8A, an image that shows weather information, an image that shows stock price information, an image that shows traffic information, and an image that shows calendar information are respectively displayed in first, second, third, and fourth split screens, for example. When the digital photo frame 300 has detected that the user is gazing at the first split screen on which the weather information is displayed, the weather information is selected so that an image that shows the weather information is displayed, as shown in FIG. 8B. Therefore, the user can select the desired split screen by gazing at the split screen. When the user is gazing at the image shown in FIG. 8B for a given time, a detailed image that shows the details of the weather information or a relevant image that shows weather-relevant information may be displayed, for example.

According to this embodiment, when the observation state (e.g., gaze state) of the user has been detected, the display state of the image displayed on the display section 340 is changed corresponding to the observation state of the user. Therefore, the variety of an image presented to the user can be increased while efficiently transmitting information. Accordingly, a novel digital photo frame can be provided.

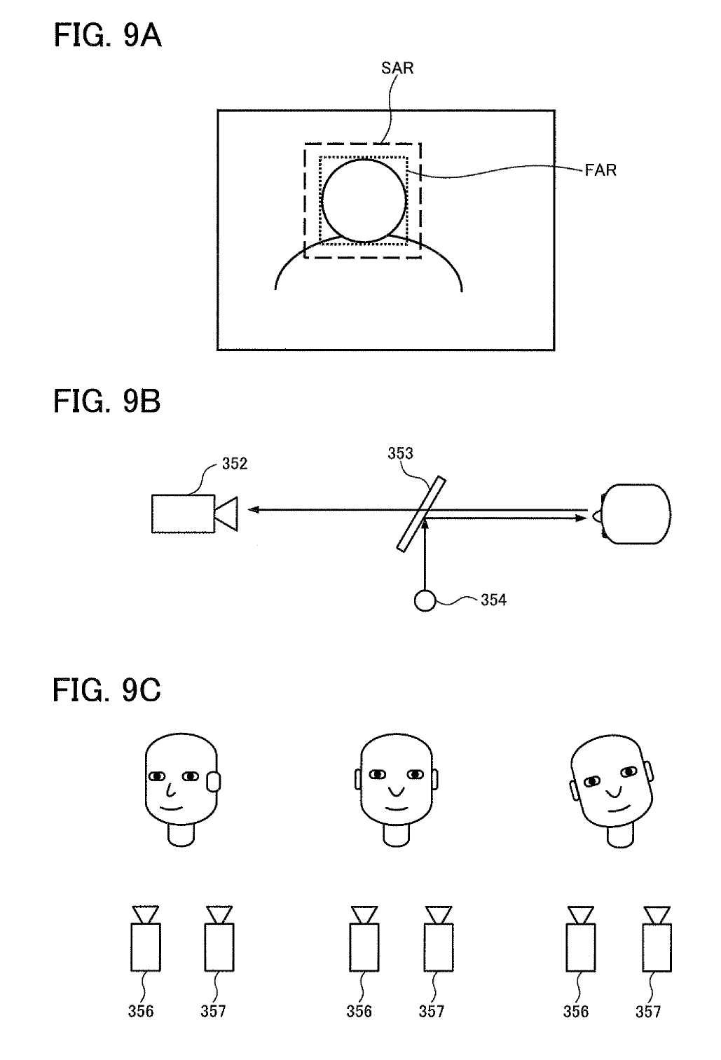

An example of a method of detecting the gaze state of the user is described below with reference to FIG. 9A. In FIG. 9A, an image sensor is used as the user detection sensor 350. The face area FAR of the user is detected based on imaging information from the image sensor, as described with reference to FIGS. 5A and 5B.

A measurement area SAR corresponding to the detected face area FAR is then set. The measurement area SAR includes the face area FAR and is larger than the face area FAR. The measurement area SAR may be set by increasing the size of the face area FAR, for example. The time in which the face area FAR is positioned within the measurement area SAR is measured, and whether or not the user is gazing at the display section 340 is determined based on the measured time. For example, it is determined that the user is gazing at the display section 340 when the face area FAR has been positioned within the measurement area SAR for a period of time equal to or longer than a given time. The display state of the image displayed on the display section 340 is then changed as shown FIGS. 6A to 8B.

According to the detection method shown in FIG. 9A, detection of the distance between the user and the display section 340 by the method shown in FIGS. 5A and 5B and detection of the gaze state can be implemented using the image sensor. This makes it possible to reduce the number of parts of the sensor while ensuring efficient processing.

Note that the gaze state detection method is not limited to the method shown in FIG. 9A. In FIG. 9B, the gaze state is detected by emitting infrared radiation and detecting the red eyes of the user, for example. Specifically, infrared radiation emitted from an infrared device 354 is reflected by a half mirror 353, and reaches the eyes of the user. The red eye state of the user is photographed and detected by a camera 352 provided with an image sensor to detect the positions of the pupils of the user (i.e., the line-of-sight direction of the user) to determine whether or not the user is gazing at the display section 340. In FIG. 9C, the positions of the pupils of the user are detected from the light and shade of an image area around the eyes of the user included in an image of the face of the user photographed by two cameras 356 and 357 (stereo camera). The line-of-sight direction of the user is detected from the center positions of the pupils and the center positions of the eyeballs to determine whether or not the user is gazing at the display section 340. The gaze state of the user can be detected by various methods.

An example in which the display state of the image displayed on the display section 340 is changed while detecting the distance between the user and the display section 340 or the gaze state of the user has been described above. Note that this embodiment is not limited thereto. For example, the display state of the image displayed on the display section 340 may be changed while detecting the approach state of the user within the detection range. For example, the change rate of the size of the face area FAR shown in FIG. 5A with respect to the time is calculated. It is determined that the user quickly approaches the display section 340 when the change rate of the size of the face area FAR is equal to or larger than a given value, and the display state of the image displayed on the display section 340 is changed in the same manner as in FIGS. 3A to 4B and FIGS. 6A to 8B. Therefore, various images can be displayed for the user who is interested in the digital photo frame and has approached the digital photo frame.

Whether or not the user is positioned within the detection range may be detected by the user detection sensor 350, and the display operation of the display section 340 may be turned ON when it has been determined that the user is positioned within the detection range. For example, the mode of the display section 340 is changed from a power-saving mode to a normal mode, and an image is displayed on the display section 340. When it has been determined that the user has moved to an area outside the detection range in a state in which the display section 340 is turned ON, the display operation of the display section 340 is turned OFF. This prevents a situation in which an image is displayed on the digital photo frame when the user is positioned away from the digital photo frame so that power is unnecessarily consumed by the digital photo frame.

When it has been detected that the user is gazing at the display section 340, the display mode may be changed on condition that it has been detected that the user is gazing at the display section 340 only once, or may be changed on condition that it has been detected that the user is gazing at the display section 340 a plurality of times. For example, the display state of the image displayed on the display section 340 is changed based on the number of times that the user has gazed at the display section 340.

Specifically, a gaze count (i.e., the number of times that the user has gazed at the display section 340 within a given time) is counted and recorded. The original image (first image) is displayed without changing the display mode until the gaze count within a given time exceeds a given number (e.g., 2 to 5) that is a threshold value. When the gaze count within a given time has exceeded a given number, the display mode is changed to the gaze mode, for example. An image relevant to the original image or a detailed image of the original image is then displayed. Alternatively, when the gaze count is large, the display frequency of the detailed image of the original image or the image relevant to the original image is increased, for example. For example, when it has been detected that the user has gazed at the display section 340 twice or more (given number) within 30 seconds (given time) when an image of a specific content is displayed, an image of a detailed content or a content relevant to the specific content is displayed. Alternatively, when it has been detected that the user has gazed at an image of a specific content five times (given number) or more within one day (given time), the display frequency of an image of a content relevant to the specific content is increased. For example, when the gaze count of the first image (e.g., an image that shows professional baseball game results) on the preceding day is equal to or more than a given number, the display frequency of the first image or an image relevant to the first image (e.g., an image that shows professional baseball game results or Major League baseball game results) on the next day is increased.

When changing the display mode using the method according to this embodiment, convenience to the user may be impaired if the display mode changes to the previous display mode immediately after the presence of the user or the observation state of the user cannot be detected. For example, when the display mode has changed to the detailed display mode or the gaze mode after the face of the user or the gaze state of the user has been detected, smooth display is impaired if the detailed display mode or the gaze mode is canceled and the previous display mode is recovered immediately after the user has momentarily looked aside, so that convenience to the user is impaired.

In order to prevent such a situation, the digital photo frame waits (i.e., maintains the display mode) for a given time (e.g., 30 seconds) before canceling the display mode. Specifically, when the display mode has changed from the simple display mode to the detailed display mode, the digital photo frame waits (i.e., maintains the detailed display mode) for a given time before canceling the detailed display mode. When the display mode has changed to the gaze mode, the digital photo frame waits for a given time before canceling the gaze mode. When the presence of the user or the gaze state of the user cannot be detected after the given time has elapsed, the digital photo frame changes the display mode from the detailed display mode to the simple display mode, or changes the display mode from the gaze mode to the normal display mode. This effectively prevents a situation in which the display mode frequently changes so that an image that is inconvenient to the user is displayed.

4. Specific Example of Display State Change Method

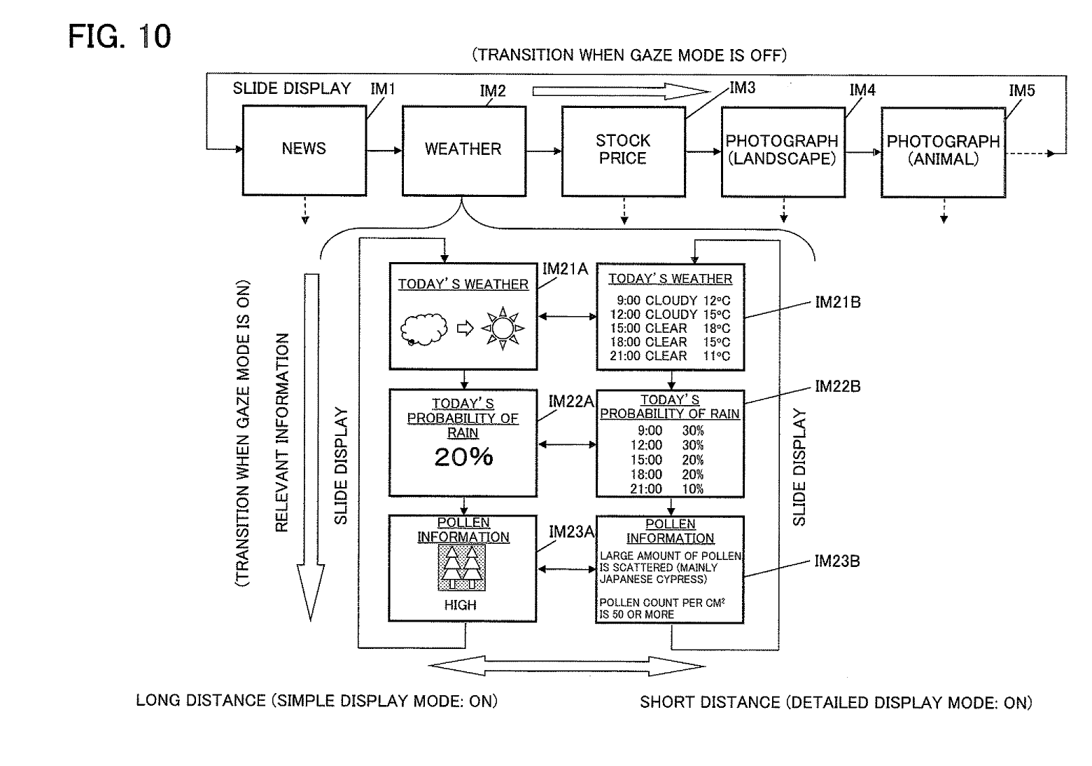

A specific example of the display state change method according to this embodiment is described below with reference to FIG. 10.

As shown in FIG. 10, when it has been determined that the user is not gazing at the display section 340 so that the gaze mode has been canceled (OFF), images IM1 to IM5 (first to Nth images in a broad sense) are sequentially displayed. Specifically, each of the images IM1 to IM5 is sequentially displayed for a given time. The images IM1 to IM5 differ in contents (theme). Specifically, the images IM1, IM2, IM3, IM4, and IM5 respectively show news, weather, stock prices, a landscape photograph, and an animal photograph.

Suppose that the user is gazing at the display section 340 when the image IM2 (Kth image in a broad sense) is displayed, for example. In this case, the display mode is set to the gaze mode (ON), and gaze images IM21A, IM22A, and IM23A that are images relevant to (or detailed images of) the image IM2 are displayed on the display section 340. For example, when the user is gazing at the weather image IM2 when the weather image IM2 is displayed, relevant images that show the probability of rain, pollen information, and the like are displayed.

When the user has approached the display section 340 when the gaze images IM21A to IM23A (first to Mth gaze images in a broad sense) are sequentially displayed, images IM21B, IM22B, and IM23B that are detailed images (a detailed image of an Lth gaze image in a broad sense) of the gaze images IM21A, IM22A, and IM23A are displayed. Specifically, when the distance between user and the display section 340 has become shorter than a given distance, the display mode changes from the simple display mode to the detailed display mode so that the detailed image is displayed. For example, the image IM21B shows the details of the weather every three hours, the image IM22B shows the details of the probability of rain every three hours, and the image IM23B shows the details of pollen information. When the user is gazing at one of the images IM1, IM3, IM4, and IM5 when that image is displayed, the display mode changes in the same manner as described above so that the display state of the image displayed on the display section 340 changes.

According to the display state change method shown in FIG. 10, when the user is gazing at an image in which the user is interested when the images IM1 to IM5 are sequentially displayed, an image relevant to or a detailed image of the image at which the user is gazing is displayed. Therefore, an image corresponding to the interest of the user can be efficiently displayed while changing the display state of the image in various ways corresponding to the gaze state or the approach state of the user, so that a novel digital photo frame can be provided.

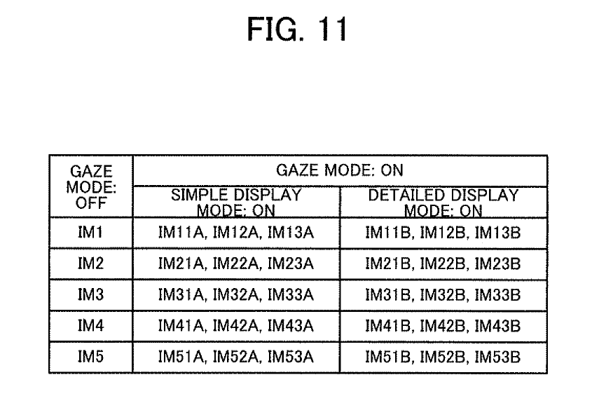

FIG. 11 shows an example of the data structure of an image used to implement the method shown in FIG. 10. In FIG. 11, the images IM1 to IM5 are associated with a gaze mode OFF flag, for example. Therefore, the images IM1 to IM5 are displayed when the user is not gazing at the display section 340. Images IM11A to IM53A are associated with the gaze mode OFF flag and a simple display mode ON flag, and images IM11B to IM53B are associated with the gaze mode OFF flag and a detailed display mode ON flag. Images IM11A to IM13B are associated with the image IM1, the images IM21A to IM23B are associated with the image IM2, images IM31A to IM33B are associated with the image IM3, images IM41A to IM43B are associated with the image IM4, and images IM51A to IM53B are associated with the image IM5. According to such a data structure, the images IM21A to M23A can be displayed when the user is gazing at the image IM2, and the images IM21B to IM23B can be displayed when the user has approached the display section 340 in this state, as shown in FIG. 10.

5. Specific Processing Example

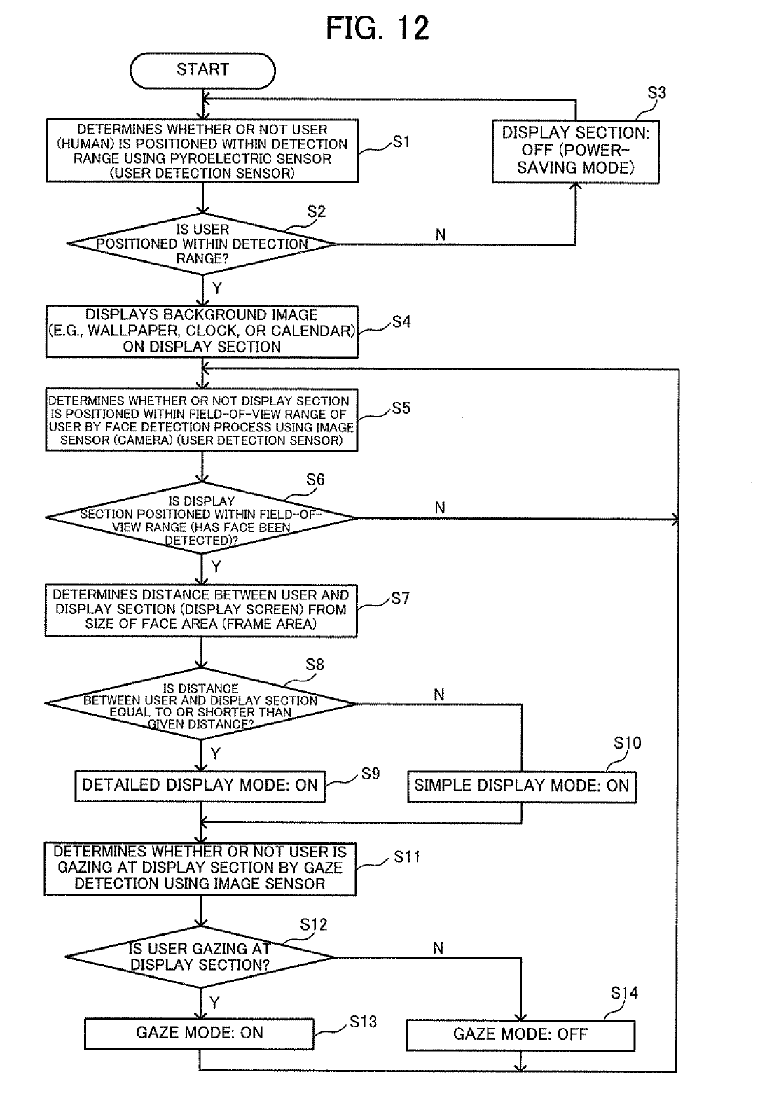

A specific processing example according to this embodiment is described below using a flowchart shown in FIG. 12.

First, whether or not the user (human) is positioned within the detection range is determined using the pyroelectric sensor (i.e., user detection sensor) (step S1). Specifically, the pyroelectric sensor is used to roughly detect whether or not the user is positioned near the digital photo frame. The user state can be efficiently detected by selectively utilizing the pyroelectric sensor and the image sensor as the user detection sensor.

When it has been determined that the user is not positioned near the digital photo frame (step S2), the display section is turned OFF (i.e., set to a power-saving mode) (step S3). When it has been determined that the user is positioned near the digital photo frame, the display section is turned ON, and a background image (e.g., wallpaper, clock, or calendar) is displayed (step S4). This prevents a situation in which an image is displayed on the display section even if the user is not positioned near the digital photo frame so that unnecessary power consumption occurs.

Whether or not the display section is positioned within the field-of-view range of the user is then determined by the face detection process using an image sensor (camera) (i.e., user detection sensor) (step S5). When it has been determined that the display section is positioned within the field-of-view range of the user (step S6), the distance between the user and the display section (display screen) is determined from the size of the face area (frame area) (step S7). For example, when the face area has been detected as shown in FIGS. 5A and 5B, it is determined that the display section is positioned within the field-of-view range of the user. The size of the face area is then detected to determine (estimate) the distance between the user and the display section.

When it has been determined that the distance between the user and the display section is equal to or shorter than a given distance (step S8), the display mode is set to the detailed display mode (step S9). When it has been determined that the distance between the user and the display section is longer than a given distance, the display mode is set to the simple display mode (step S10). The image displayed on the display section can thus be changed between the simple image and the detailed image corresponding to the distance between the user and the display section, as described with reference to FIGS. 3A and 3B.

Whether or not the user is gazing at the display section is then determined by a gaze detection process using the image sensor (step S11). When it has been determined that the user is gazing at the display section (step S12), the display mode is set to the gaze mode (ON) (step S13). When it has been determined that the user is not gazing at the display section, the display mode is not set to the simple display mode (OFF) (step S14). The display state can thus be changed corresponding to whether or not the user is gazing at the display section, as described with reference to FIGS. 6A and 6B.

The details of the gaze state detection process described with reference to FIG. 9A are described below with reference to FIG. 3.

The face area (frame area) is detected by the face detection process using the image sensor (camera) (step S21). Specifically, the face area is detected by the method described with reference to FIGS. 5A and 5B. A measurement area that includes the detected face area and is larger than the face area is set (step S22). Specifically, a measurement area is set by increasing the size of the face area, as shown in FIG. 9A. The time in which the face area is positioned within the measurement area is measured using a timer (step S23). Specifically, the time is measured using the timer after setting the measurement area to measure the time in which the face area is positioned within the measurement area. Whether or not a time equal to or more than a given time has elapsed is determined (step S24). When a time equal to or more than a given time has elapsed, the display mode is set to the gaze mode (step S25). When a time equal to or more than a given time has not elapsed, the display mode is not set to the gaze mode (OFF) (step S26). According to this configuration, the gaze state of the user can be detected while setting the gaze mode corresponding to the gaze state of the user.

6. Modification

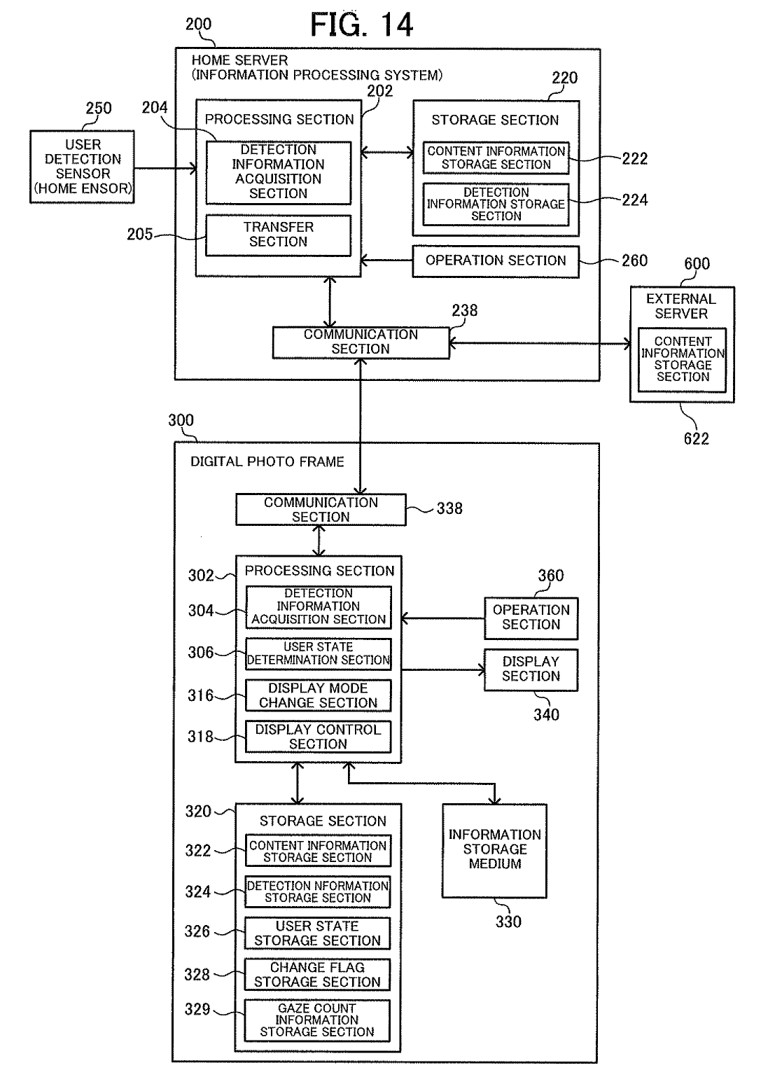

Modifications of this embodiment are described below. FIG. 14 shows a first modification of this embodiment. A system according to the first modification includes a home server 200 (information processing system in a broad sense). The home server 200 includes a processing section 202, a storage section 220, a communication section 238, and an operation section 260. Note that various modifications may be made, such as omitting some of these elements or adding other elements. The same elements as the elements shown in FIG. 2 are indicated by the same symbols. Description of these elements is omitted.

The processing section 202 performs various processes such as a management process. The processing section 202 may be implemented by a processor (e.g., CPU), an ASIC, or the like. The storage section 220 serves as a work area for the processing section 202 and the communication section 238. The storage section 220 may be implemented by a RAM, an HDD, or the like. The communication section 238 communicates with the digital photo frame 300 and an external server 600 via cable communication or wireless communication. The communication section 238 may be implemented by a communication ASIC, a communication processor, or the like. The operation section 260 allows the administrator of the server to input information.

In FIG. 14, the digital photo frame 300 and the home server 200 are connected via a network such as a wireless LAN. In FIG. 14, a home sensor installed in a house is used as a user detection sensor 250. A detection information acquisition section 204 of the home server 200 acquires detection information from the user detection sensor 250 (i.e., home sensor), and the detection information acquired by the detection information acquisition section 204 is stored in a detection information storage section 224.

The detection information acquired by the home server 200 is transferred to the digital photo frame 300 by a transfer section 205 through the communication sections 238 and 338. The detection information acquisition section 304 of the digital photo frame 300 acquires the detection information transferred from the home server 200, and the detection information acquired by the detection information acquisition section 304 is stored in the detection information storage section 324. The user state determination section 306 determines the user state based on the detection information, and the display mode change section 316 changes the display mode corresponding to the user state. For example, the display mode change section 316 changes the display mode corresponding to the positional relationship between the user and the display section, the observation state of the user, or the like. The display control section 318 causes the display section 340 to display an image corresponding to the display mode. For example, when the display mode is set to the simple display mode, the detailed display mode, or the gaze mode, the simple image, the detailed image, or the gaze image (relevant image) is displayed on the display section 340. Note that the content information (e.g., image) is downloaded from a content information storage section 222 of the home server 200 to the content information storage section 322 of the digital photo frame 300. Alternatively, the content information may be downloaded from a content information storage section 622 of the external server 600. A program that implements the processing section 302 of the digital photo frame 300 may be downloaded to the digital photo frame 300 from the external server 600 or the home server 200.

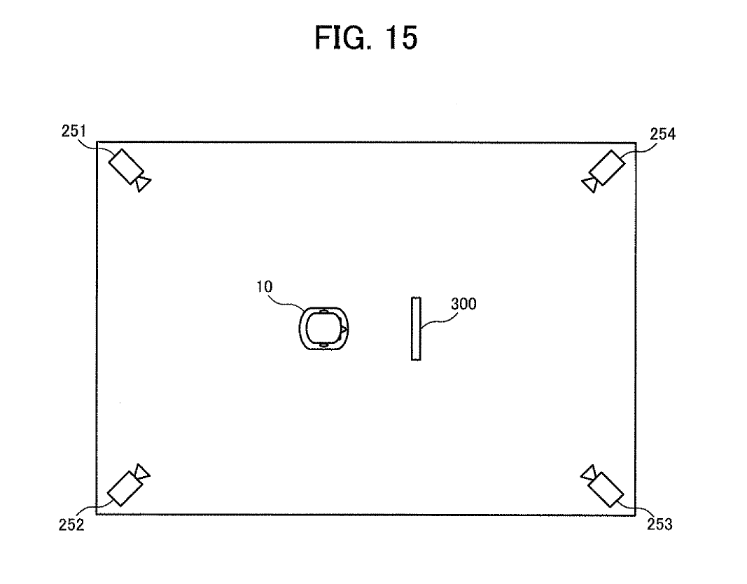

FIG. 15 shows an installation example of the home sensor (i.e., user detection sensor 250). In FIG. 15, cameras 251, 252, 253, and 254 that include an image sensor are installed as the home sensors at four corners of a ceiling of a room, for example. The user 10 and the digital photo frame 300 are photographed using the cameras 251 to 254 to acquire the detection information for determining the positional relationship between the user 10 and the display section 340 of the digital photo frame 300, the observation state of the user 10 with respect to the display section 340, whether or not the user 10 is positioned within the room (i.e., detection range), or the like. The acquired detection information is transferred from the home server 200 to the digital photo frame 300, and the digital photo frame 300 determines the user state based on the detection information, and displays an image corresponding to the user state on the display section 340. Note that the home sensor is not limited to the image sensors of the cameras 251 to 254. Various sensors such as a pyroelectric sensor or an ultrasonic sensor may be used as the home sensor.

According to the first modification shown in FIG. 14, the detection information can be acquired by effectively utilizing the home sensor provided for home security or the like, the user state can be determined based on the detection information, and an image corresponding to the user state can be displayed on the display section 340 of the digital photo frame 300.

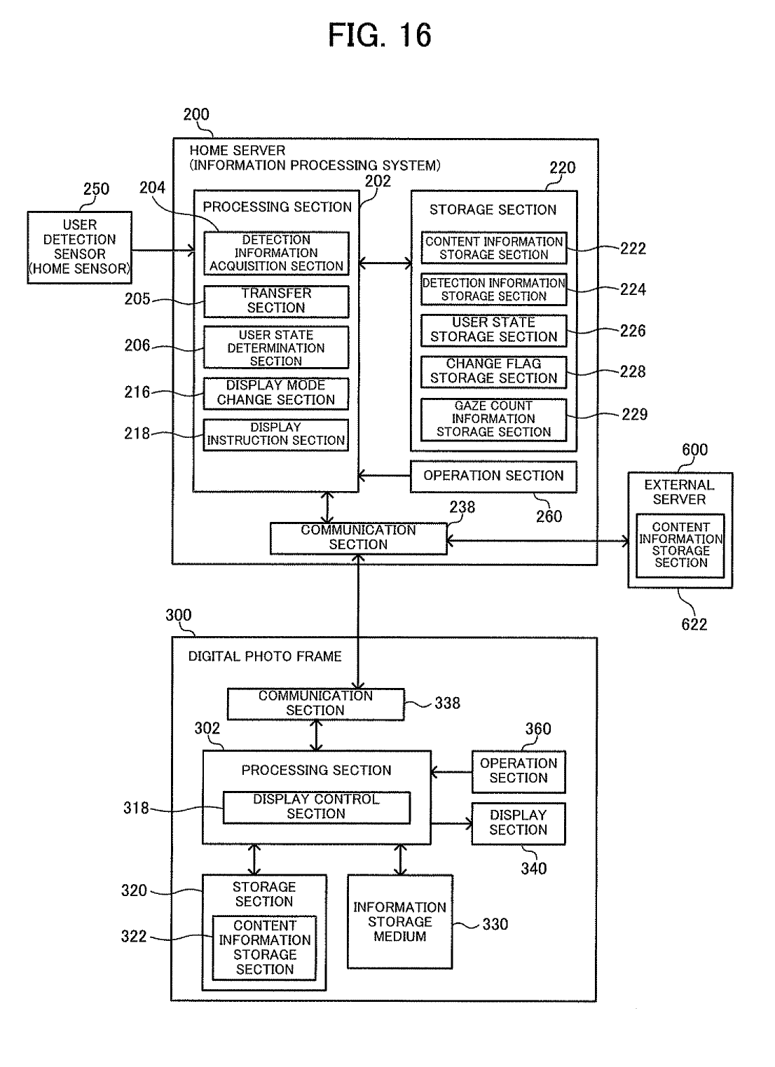

FIG. 16 shows a second modification of this embodiment. In FIG. 16, the processing section 202 of the home server 200 includes a user state determination section 206 and a display mode change section 216 in addition to the detection information acquisition section 204 and the transfer section 205. The processing section 202 also includes a display instruction section 218 that issues display instructions to the digital photo frame 300. The storage section 220 of the home server 200 includes a user state storage section 226, a change flag storage section 228, and a gaze count information storage section 229 in addition to the content information storage section 222 and the detection information storage section 224.

In FIG. 16, the user state determination section 206 of the home server 200 determines the user state (e.g., positional relationship or observation state) based on the detection information from the home sensor (i.e., user detection sensor 250). The display mode change section 216 changes the display mode corresponding to the user state. For example, the display mode change section 216 changes the display mode corresponding to the positional relationship between the user and the display section, the observation state of the user, or the like. The display instruction section 218 instructs the digital photo frame 300 to display an image corresponding to the display mode. Specifically, the display instruction section 218 instructs the digital photo frame 300 to change the display state of the image displayed on the display section 340 corresponding to at least one of the positional relationship between the user and the display section 340, the observation state of the user, and whether or not the user is positioned within the detection range. The display control section 318 of the digital photo frame 300 controls the display operation of the display section 340 according to the instructions from the display instruction section 218. Therefore, the display state of the image displayed on the display section 340 changes corresponding to the positional relationship between the user and the display section 340, the observation state of the user, or whether or not the user is positioned within the detection range.

According to the second modification shown in FIG. 16, since the home server 200 determines the user state and changes the display mode, the processing load of the digital photo frame 300 can be reduced. Therefore, the process according to this embodiment can be implemented even if the processing section 302 (CPU) of the digital photo frame 300 has low performance. Note that the above process may be implemented by distributed processing of the home server 200 and the digital photo frame 300.

Although some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention. Any term (e.g., distance and gaze state) cited with a different term (e.g., positional relationship and observation state) having a broader meaning or the same meaning at least once in the specification and the drawings can be replaced by the different term in any place in the specification and the drawings. The configurations and the operations of the digital photo frame and the information processing system, the user state determination method, the positional relationship detection method, the observation state detection method, and the like are not limited to those described relating to the above embodiments. Various modifications and variations may be made.

What is claimed is:

1. A digital photo frame comprising:
a display section that displays an image;
a display control section that controls the display section;
a detection information acquisition section that acquires detection information detected by a user detection sensor; and
a user state determination section that determines at least one of a positional relationship between a user and the display section, an observation state of the user with respect to the display section, and whether or not the user is positioned within a detection range,
the display control section changing a display state of the image displayed on the display section corresponding to at least one of the positional relationship between the user and the display section, the observation state of the user with respect to the display section, and whether or not the user is positioned within the detection range.

2. The digital photo frame as defined in claim 1,
the user state determination section determining a distance between the user and the display section as the positional relationship between the user and the display section; and
the display control section changing the display state of the image displayed on the display section corresponding to the distance between the user and the display section.

3. The digital photo frame as defined in claim 2,
the display control section increasing the degree of detail of the image displayed on the display section as the distance between the user and the display section decreases.

4. The digital photo frame as defined in claim 2,
the display control section increasing the number of screen splits of the image displayed on the display section as the distance between the user and the display section decreases.

5. The digital photo frame as defined in claim 2,
the display control section decreasing the size of a character displayed on the display section as the distance between the user and the display section decreases.

6. The digital photo frame as defined in claim 2, further comprising:
a display mode change section that changes a display mode of the display section corresponding to the distance between the user and the display section.

7. The digital photo frame as defined in claim 6,
the display mode change section changing the display mode from a simple display mode to a detailed display mode when the distance between the user and the display section has decreased.

8. The digital photo frame as defined in claim 7,
the display mode change section waiting for a given time to avoid cancelling the detailed display mode after the display mode has changed from the simple display mode to the detailed display mode.

9. The digital photo frame as defined in claim 2,
the user detection sensor being an image sensor that images the user; and
the user state determination section detecting a face area of the user based on imaging information from the image sensor, and determining the distance between the user and the display section based on the size of the detected face area.

10. The digital photo frame as defined in claim 2,
the user detection sensor being an image sensor that images the user; and
the user state determination section determining the distance between the user and the display section by performing an auto-focus process on the user.

11. The digital photo frame as defined in claim 2,
the user detection sensor being an ultrasonic sensor; and
the user state determination section determining the distance between the user and the display section using the ultrasonic sensor.

12. The digital photo frame as defined in claim 1,
the user state determination section determining whether or not the user is gazing at the display section as the observation state of the user; and
the display control section changing the display state of the image displayed on the display section corresponding to whether or not the user is gazing at the display section.

13. The digital photo frame as defined in claim 12,
the display control section changing the display state of the image displayed on the display section corresponding to gaze count information that indicates the number of times that the user has gazed at the display section.

14. The digital photo frame as defined in claim 13,
the display control section changing the image displayed on the display section from a first image to a gaze image corresponding to the first image when the number of times that the user has gazed at the first image within a given time is equal to or more than a given number.

15. The digital photo frame as defined in claim 12,
the display control section changing a display frequency of a first image or an image relevant to the first image based on the gaze count information that indicates the number of times that the user has gazed at the first image within a given time.

16. The digital photo frame as defined in claim 12,
the display control section changing the image displayed on the display section from a first image to a gaze image corresponding to the first image when the user state determination section has determined that the user is gazing at the first image.

17. The digital photo frame as defined in claim 12,
the display control section sequentially displaying first to Nth (N is an integer equal to or larger than two) images on the display section when the user state determination section has determined that the user is not gazing at the display section, and displaying a gaze image on the display section when the user state determination section has determined that the user is gazing at the display section when a Kth (1≦K≦N) image among the first to Nth images is displayed, the gaze image being an image relevant to the Kth image or a detailed image of the Kth image.

18. The digital photo frame as defined in claim 16,
the user state determination section determining a distance between the user and the display section as the positional relationship between the user and the display section; and
the display control section displaying a detailed image of the gaze image on the display section when the user state determination section has determined that the user has approached the display section when the gaze image is displayed.

19. The digital photo frame as defined in claim 16,
the display control section sequentially displaying first to Mth (M is an integer equal to or larger than two) gaze images on the display section as the gaze image when the user state determination section has determined that the user has not approached the display section, and displaying a detailed image of an Lth (1≦L≦M) gaze image among the first to Mth gaze images on the display section when the user state determination section has determined that the user has approached the display section when the Lth gaze image is displayed on the display section.

20. The digital photo frame as defined in claim 12,
the user detection sensor being an image sensor that images the user; and
the user state determination section detecting a face area of the user based on imaging information from the image sensor, setting a measurement area that includes the detected face area and is larger than the face area, measuring a time in which the face area is positioned within the measurement area, and determining whether or not the user is gazing at the display section based on the measured time.

21. The digital photo frame as defined in claim 12, further comprising:
a display mode change section that changes a display mode of the display section corresponding to whether or not the user is gazing at the display section.

22. The digital photo frame as defined in claim 21,
the display mode change section waiting for a given time to avoid cancelling a gaze mode after the display mode has changed to the gaze mode.

23. The digital photo frame as defined in claim 1,
the user state determination section determining whether or not the user is positioned within the detection range; and
the display control section causing the display section to be turned ON when the user state determination section has determined that the user is positioned within the detection range.

24. The digital photo frame as defined in claim 23,
the user state determination section determining whether or not the display section is positioned within a field-of-view range of the user as the observation state of the user after the display section has been turned ON; and
the display control section sequentially displaying first to Nth images on the display section when the user state determination section has determined that the display section is positioned within the field-of-view range of the user.

25. An information processing system comprising:
a display instruction section that instructs a display section of a digital photo frame to display an image;
a detection information acquisition section that acquires detection information detected by a user detection sensor; and
a user state determination section that determines at least one of a positional relationship between a user and the display section, an observation state of the user with respect to the display section, and whether or not the user is positioned within a detection range,
the display instruction section performing a display instruction to change a display state of the image displayed on the display section corresponding to at least one of the positional relationship between the user and the display section, the observation state of the user with respect to the display section, and whether or not the user is positioned within the detection range.

26. A method of controlling a digital photo frame comprising:
acquiring detection information detected by a user detection sensor;
determining at least one of a positional relationship between a user and a display section of the digital photo frame, an observation state of the user with respect to the display section, and whether or not the user is positioned within a detection range; and
changing a display state of an image displayed on the display section corresponding to at least one of the positional relationship between the user and the display section, the observation state of the user with respect to the display section, and whether or not the user is positioned within the detection range.
